(19) United States
(12) Patent Application Publication
(10) Pub. No.: US 2007/0067357 A1
(43) Pub. Date: Mar. 22, 2007

(54) Methods and apparatus to provide a database version control system

(76) Inventor: Nicholas Clark, Union, MO (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/230,696

(22) Filed: Sep. 20, 2005

(51) Int. Cl. G06F 17/30

(52) U.S. Cl. 707/203

(57) ABSTRACT

Methods and apparatus to provide a database version control system are disclosed. An illustrated example method comprises receiving a request to modify a first table of a database, inserting an entry in a second table in response to the request, storing information reflecting the modification in the second table, modifying the first table according to the request, and storing a unique identifier associated with the record in the second table.

### FIELD OF THE DISCLOSURE

This disclosure relates generally to databases, and, more particularly, to methods and apparatus to provide a version control system for databases.

### BACKGROUND

A database is a collection of data elements stored in one or more tables. When multiple tables are present, the database may store information regarding the relation between two or more tables. Each table includes one or more records, which include one or more fields. Typically, each row of a table represents one record. The columns of the table denote fields of data. A field in a record may store any type of data such as, for example, a number, a character, a string of characters, a bitmap image, a binary data object, etc.

The computer program that interacts with and controls the database is called a database management system (DBMS). For example, a DBMS may include functions for inserting data in the database, updating data in the database, and/or deleting data from the database. Example database management systems include Oracle® Database, IBM DB2®, Microsoft SQL Server®, MySQL®, and PostgreSQL®. Structured English Query Language (SQL®) defines a standard language that many databases recognize. SQL includes commands such as, INSERT, UPDATE, and DELETE for manipulating data in a database. The DBMS may allow a programmer to cause additional commands to be executed prior to the operation of an SQL command. For example, the DBMS may allow triggers to be added to the SQL commands so that when a command is called, other code is triggered for execution prior to the performance of the called SQL command. In addition, the DBMS may be capable of storing sequences that store a value that is used in an ordered manner in the database. For example, the database may store a sequence that is representative of a serial number. Each time a serial number is obtained from the sequence, the value of the sequence is incremented.

Recently, the need to store complex data in databases has increased. As database usage has increased, the need for more tracking and monitoring of operations performed on a database has also increased. Known systems store tracking information in a single table alongside actual data. However, this approach results in inefficiently large tables as the database and the tracking information grows.

### BRIEF DESCRIPTION OF THE DRAWINGS

FIG. 1 is a block diagram of an example database version control system constructed in accordance with the teachings of the invention.

FIG. 2 illustrates an example set of tables in an initial state of a database managed by the example version control system of FIG. 1.

FIG. 3 illustrates the example tables of FIG. 2 following the insertion of data.

FIG. 4 illustrates the example tables of FIG. 3 following an update operation.

FIG. 5 illustrates the example tables of FIG. 4 following a second update operation.

FIG. 6 illustrates the example tables of FIG. 5 following a delete operation.

FIG. 7 is a flow diagram representative of machine readable instructions that may be executed in response to an INSERT operation performed on the database.

FIG. 8 is a flow diagram representative of machine readable instructions that may be executed in response to an UPDATE operation performed on the database.

FIG. 9 is a flow diagram representative of machine readable instructions that may be executed in response to a DELETE operation performed on the database.

FIG. 10 is pseudo code illustrating an example implementation of an INSERT trigger in an Oracle database.

FIG. 11 is pseudo code illustrating an example implementation of an UPDATE/DELETE trigger in an Oracle database.

FIG. 12 is pseudo code illustrating an example implementation of a SECURITY trigger in an Oracle database.

FIG. 13 is an example processor-based system capable of executing the example instructions represented in FIGS. 7, 8, 9, 10, 11, and/or 12 to implement the example apparatus of FIG. 1.

### DETAILED DESCRIPTION

Methods and apparatus to provide database version control are disclosed. An example method described herein recognizes requests to modify or insert data stored in a primary set of data in a database. In response to the request, the example method stores information reflecting the modification in a historical set of data. In addition, a unique identifier associated with the data to be modified by the request is stored in the historical data to associate the historical data with the data stored in the primary set of data. Accordingly, the illustrated method tracks modifications made to a primary set of data.

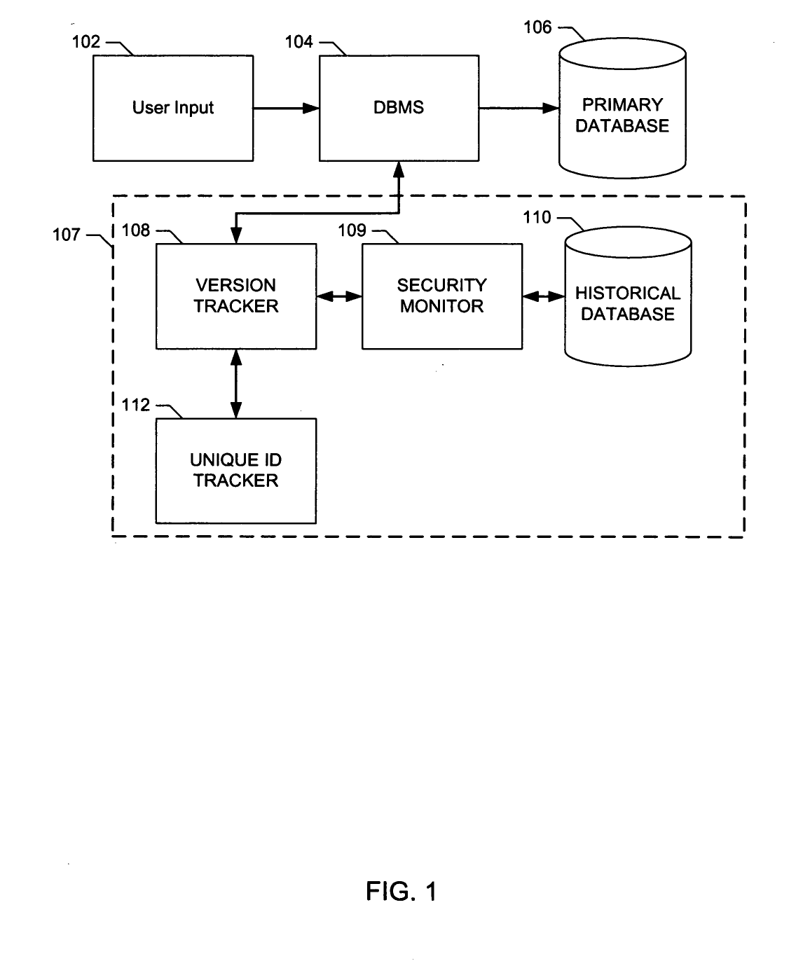

FIG. 1 is a block diagram of an example version control system 107 for a database management system (DBMS) 104. The DBMS 104 may be any available DBMS such as, for example, Oracle® Database, IBM DB2®, Microsoft SQL Server®, MySQL®, and PostgreSQL®. The DBMS 104 is capable of managing a primary database 106. The primary database 106 may include any number of tables storing any type of data. For example, the primary database may include a first table storing contact information about a business' customers and a second table storing purchase history information about the customers in the first table. The DBMS 104 is capable of receiving a user input 102. The user input 102 may provide instructions to the DBMS 104 to return data matching desired criteria, insert a record in a table of the primary database 106, update data in a record in a table of the primary database 106, delete a record from a table of the primary database 106, and/or perform any other task.

The example version control system 107 includes a version tracker 108, a security monitor 109, a historical database 110, and a unique identifier (ID) tracker 112. In the illustrated example, the version tracker 108 is structured to monitor the user input 102, the DBMS 104, and/or the primary database 106 to record when modifications to the primary database 106 are made. For example, the illustrated version tracker 108 determines when the user input 102 instructs the DBMS 104 to modify the primary database 106. In response to such an instruction, the version tracker 108 of the illustrated example obtains a copy of the data before the modification is made to the primary database 106 and stores the copy of the data in the historical database 110. In other words, the primary database 106 stores the current state of data while the historical database 110 stores past state(s) of data. In addition, the historical database 110 may store the initial state of records as they are first inserted in the primary database 106.

The version tracker 108 of the illustrated example is additionally capable of storing a unique ID in a unique ID field in the primary database 106 and in a unique ID field in the historical database 110. The unique ID tracker 112 is capable of storing and/or tracking a unique ID variable that can be retrieved by the version tracker 108. In the illustrated example, the unique ID tracker 112 ensures that ID numbers are unique to avoid ambiguities. When the version tracker 108 of the illustrated example is first installed or initialized, it creates a column in each table of the primary database 106 to store a unique ID and associates a unique ID obtained from the unique ID tracker 112 with each record in the primary database 106. When the version tracker 108 stores version tracking data in the historical database 110, the unique ID is stored in the historical database 110 as well. The unique ID links records in the primary database 106 with records in the historical database 110. In other words, the historical data for a record in the primary database 106 can be located by querying the historical database 110 for all records that have the same unique ID as the record in the primary database 106.

The version control system 107 includes a security monitor 109, which acts as a security agent for the historical database 110. The security monitor 109 ensures that the data in the historical database 110 is not accidentally or intentionally modified. For example, if the user input 102 instructs the DBMS 104 to perform a modification on the historical database 110, the security monitor 109 may override the instruction and prevent the DBMS 104 from modifying the historical database 110. The security monitor 109 may alternatively, selectively allow the modification of a subset of the columns in the historical database 110, may allow certain users to make modifications to the historical database 110, or may utilize any combination of the foregoing policies. The security monitor 109 may access a second historical database similar to historical database 110 capable of storing information associated with modifications to the historical database 110. The second historical database may store information that may be used to track changes made to the historical database 110.

While the example version control system 107 is illustrated as a group of components separate from the DBMS 104 and primary database 106, persons of ordinary skill in the art will recognize that one or more of the components of the version control system 107 may be implemented as a part of the DBMS 104 and/or the primary database 106. For example, the version tracker 108, the security monitor 109, and/or the unique ID tracker 112 may be implemented as a part of the DBMS 104. In particular, the version tracker 108 and/or the security tracker 109 may be implemented as one or more triggers that cause instructions to be executed by the DBMS 104 to cause the DBMS 104 to store data in the historical database 110 or to stop modification of the historical database 110 as described above. Additionally, the historical database 110 may be implemented as a part of the primary database 106. The primary database 106 may include one or more tables for storing historical data or historical data may be stored in the same table as the primary data in the primary database 106.

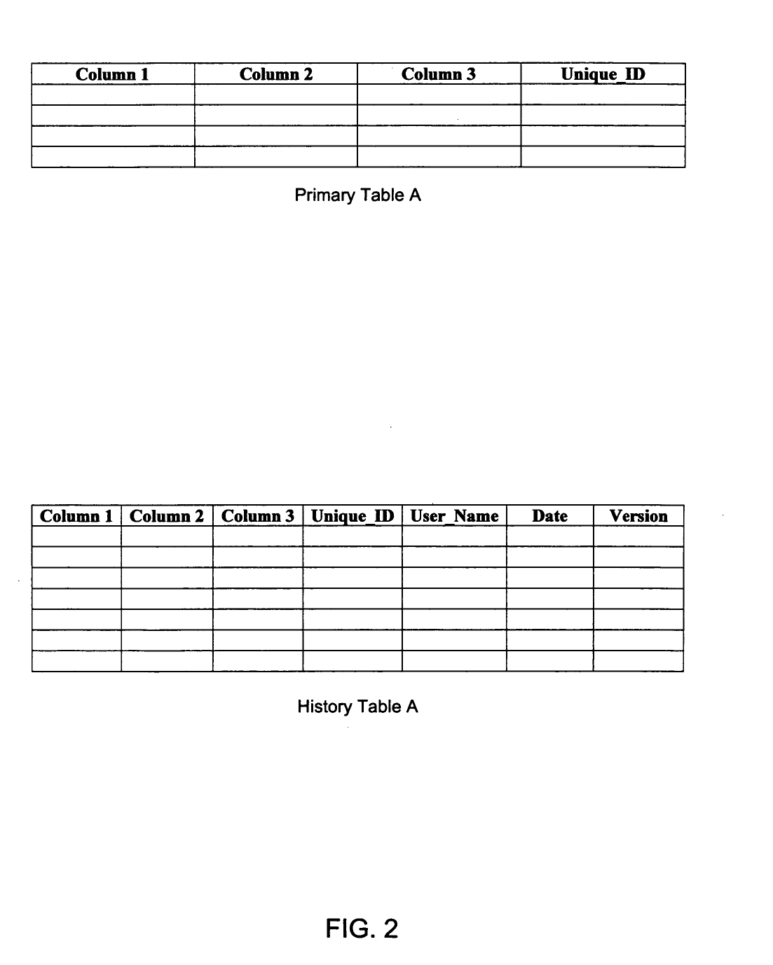

FIGS. 2-6 are tables illustrating various states of an example database managed by the version control system 107 of FIG. 1. As illustrated, an example implementation of the history database 110 includes a history table for each of the primary tables in the primary database 106. The use of a separate history table allows history data to be stored without affecting the size of the primary table. A smaller primary table may be queried quicker than a large primary table including historical data. Thus, it is advantageous to maintain the history table separate from the primary table. In addition, one or more maintenance scripts may be provided to periodically or a periodically remove undesired data from the history table. For example, a maintenance script may remove data that is older than a predefined threshold to keep the history table at a manageable size.

While FIGS. 2-6 include one table-set comprising one primary table and one history table, it will be understood by persons of ordinary skill in the art that, as described above, any number of table-sets may be included in the database(s) 106, 110. Further, persons of ordinary skill in the art will recognize that various combinations of primary and history tables may be implemented such as, for example, one history table for the entire system, two or more history tables for each primary table, or various combinations of history tables and primary tables.

FIG. 2 illustrates an example state of the example database 106, 110 before any data has been inserted into either of the tables. FIG. 1 includes a primary table A and a history table A that is associated with the primary table A. The primary table A includes three example columns of data (column 1, column 2, and column 3) and a unique identifier (ID) column. In the illustrated example, columns 1-3 may store any type of data such as, for example, text, numbers, dates, times, etc.

The unique ID column is structured to store a serial number that is unique to each record or row in the primary table A. The unique ID value may be unique to each record in the primary table A or may be unique to every record in the entire database depending on the desired implementation. Of course, the unique ID column may store any value that is unique to each record in the data such as, for example, a number, a text value, a date and time value, and/or any combination thereof. The unique ID may be obtained from the unique ID tracker 112 of FIG. 1. Of course, any other method for keeping track of the unique ID value for future generation may be used such as, for example, the primary database 106 or the historical database 110 may store a record in a system table with the last unique ID value that was used or the version tracker 108 may locate the greatest unique ID value in any record of the primary database 106.

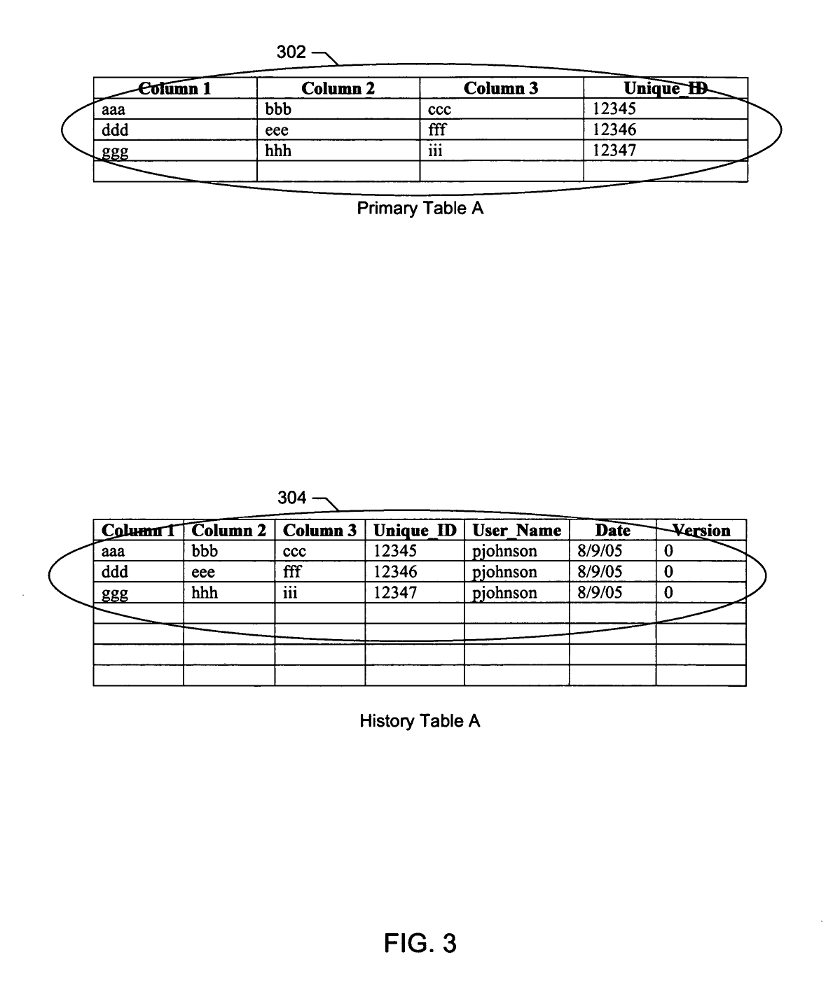

The illustration of FIG. 2 also includes a history table A associated with the primary table A. The history table A includes the same columns as the primary table A (column 1, column 2, column 3, and unique ID) and additionally includes a user name column, a date column, and a version number column. The history table is capable of storing copies of data from the primary table A as will be illustrated in FIGS. 3-6.

In the illustrated example, the user name column in the history table is structured to store the name of a user that performed an operation that caused data to be stored in the history table A (e.g., inserted data in the primary table A, updated data in the primary table A, deleted a record from the primary table A). The user name column may be derived from the username a user used in connecting to the database, a username the user used to connect to a network, and/or a name value associated with the computer the user used to connect to the database.

In the illustrated example, the date column is structured to store the date that a row of data was inserted into the history table. The date column may additionally or alternatively store a time value, if desired. The date column may store a date representative of any event that has occurred such as, for example, the date that a record was first inserted in the database.

In the illustrated example, the version column is structured to store a value indicative of the version of data that is stored in a row of the history table A. For instance, in the illustrated example, when data is first inserted in the primary table A, it is also inserted in the history table A with the value of “0” stored in the version field. Upon a change to the row in the primary table A, a copy of the data is stored in the history table A with a version number corresponding to the number of times the row has been changed (i.e., modified, deleted, etc.) For example, the first time the row is changed, an entry with the version field storing “1” is inserted in the table. Upon the next, update or delete, a copy of the changed row data is stored in the history table A with the version field storing “2”. Of course, any other desired method of assigning version numbers to entries in the historical data may be used. For example, letters may be used to represent version numbers.

Persons of ordinary skill in the art will recognize that the history table may include columns other than those discussed above. Indeed, any data capable of being stored in a database may be stored in the history table A. For example, the history table A may store the type of operation that was performed on the primary table, the address of a computer that sent the request to perform an operation, etc.

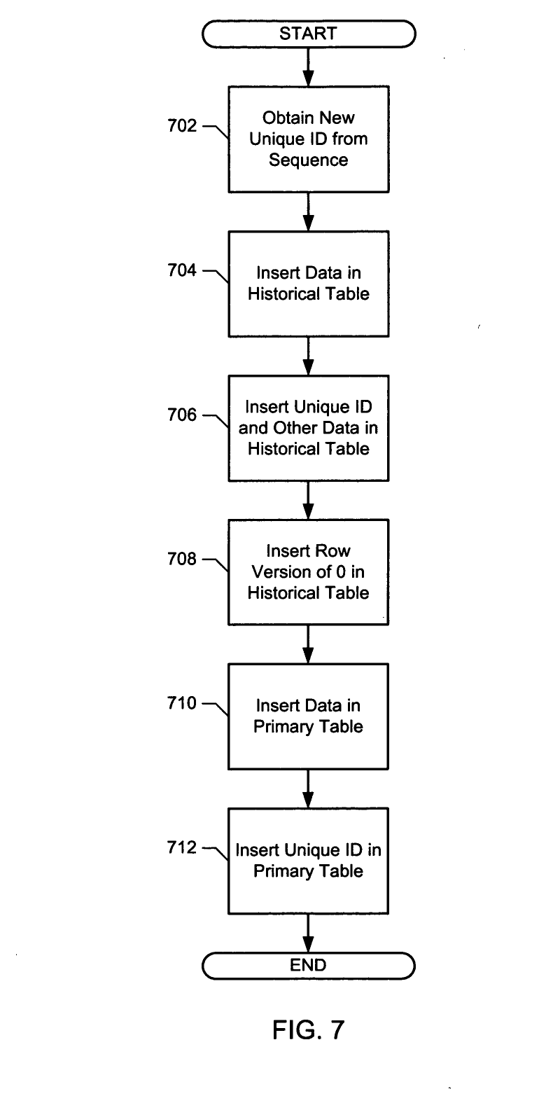

FIG. 3 illustrates an example state of the database of FIG. 2 after three records (label 302) have been inserted in the primary table A of the database. Consecutive unique IDs have been assigned to each record and inserted in the primary table A. As illustrated, the records from primary table A have also been inserted in the history table A (label 304). In addition, the history table A indicates that user ‘pjohnson’ inserted the data on Aug. 10, 2005. An example method of inserting data in the primary table A and the history table A will be described in further detail in conjunction with FIG. 7.

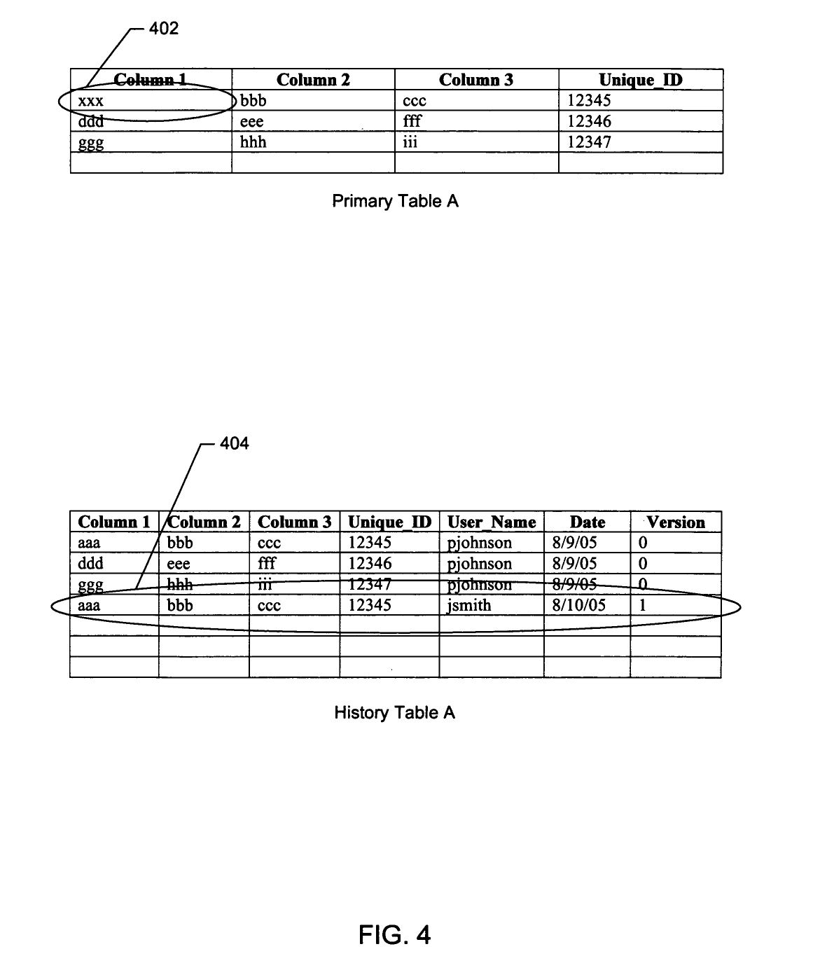

FIG. 4 illustrates an example state of the database after column 1 of the first record 12345 has been updated (label 402) relative to the state shown in FIG. 3. In the illustrated example, column 1 of the first record 12345 is changed from ‘aaa’ to ‘xxx.’ As a result, a new record (label 404) has been added to the history table A. The new record (label 404) comprises the data before the aforementioned update was applied and indicates that the update was made by user ‘jsmith’ on Aug. 10, 2005. The version number 1 indicates that the update was the first change following the insertion of the data in the primary table A.

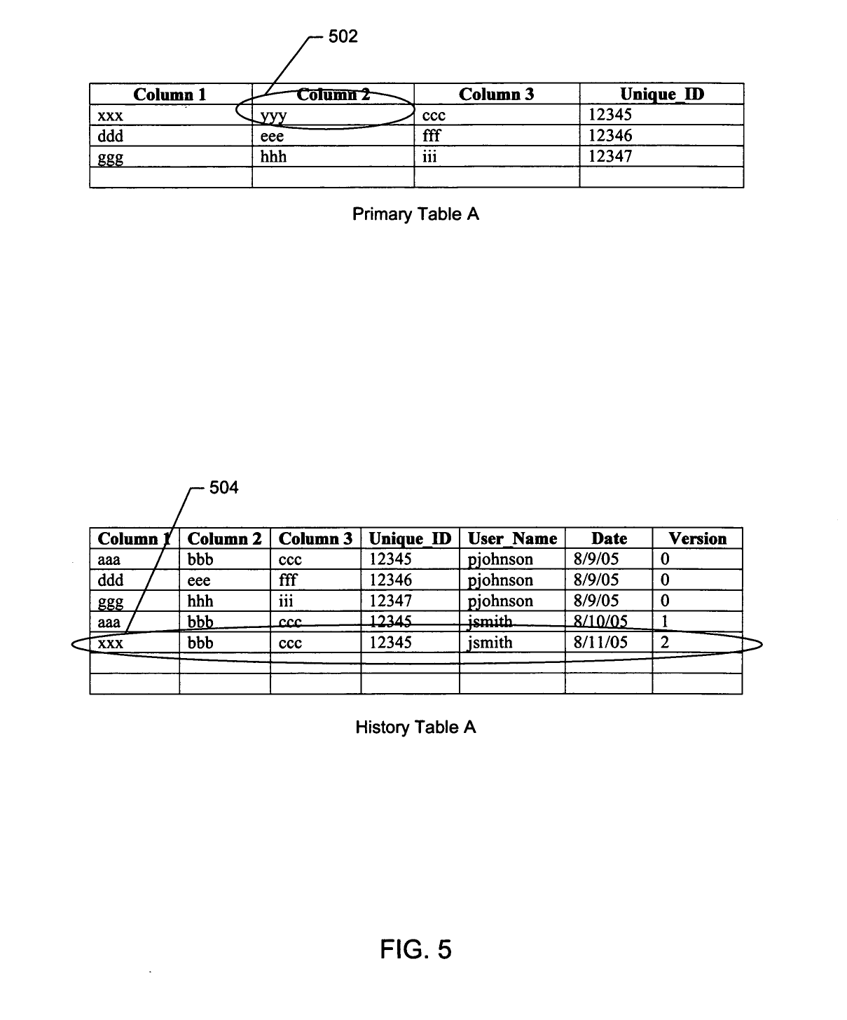

FIG. 5 illustrates an example state of the database after column 2 of the first record 12345 has been updated (label 502), relative to the example state illustrated in FIG. 4. In the illustrated example, column 2 of the first record 12345 has been changed from ‘ccc’ to ‘yyy.’ As a result, a new record (label 504) has been added to the history table A. The new record (label 504) comprises the data before the aforementioned update was applied (after the update illustrated in FIG. 4) and indicates that the update was made by user ‘jsmith’ on Aug. 11, 2005. The version number 2 indicates that the update was the second change following the insertion of the data in the primary table A.

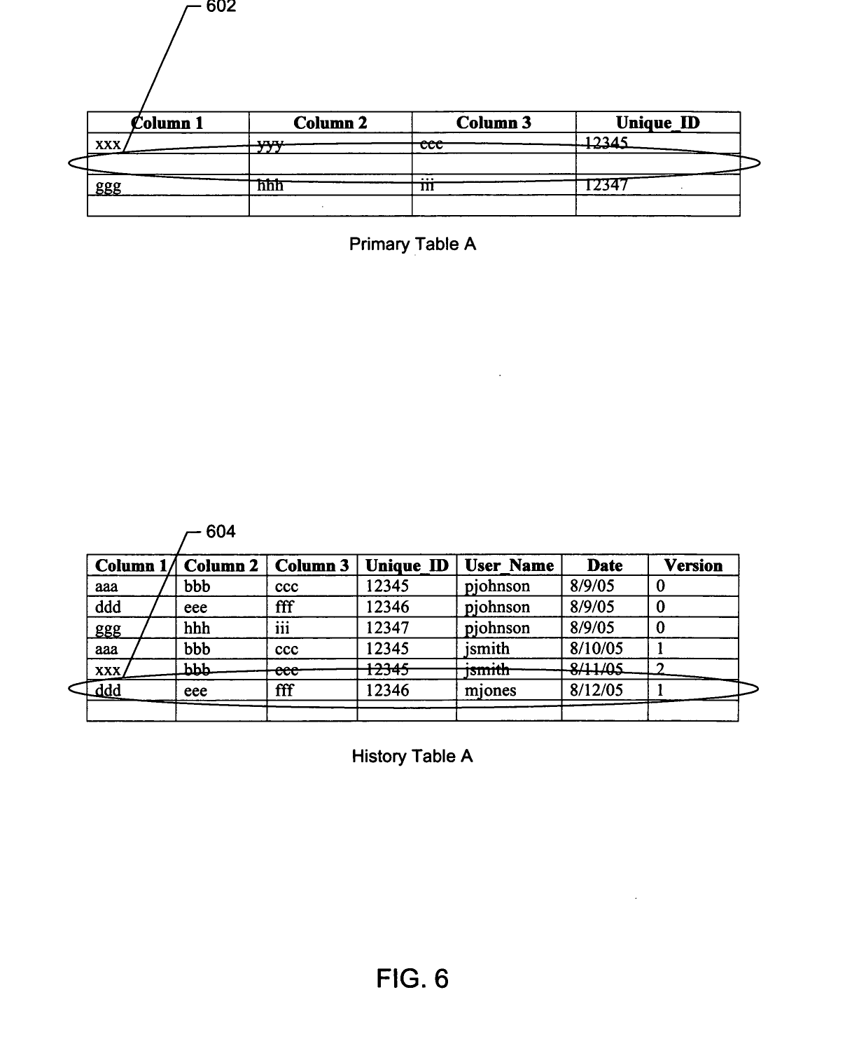

FIG. 6 illustrates an example state of the database at a point in time after the example state shown in FIG. 5, namely, when the second record 12346 has been deleted (label 602). In this example, a new record (label 604) has been added to the history table A. The new record (label 604) comprises the data before the aforementioned delete was applied (after the update illustrated in FIG. 5) and indicates that the delete was made by user ‘mjones’ on Aug. 12, 2005. The version number 1 indicates that the update was the first change following the insertion of the data in the primary table A.

Flowcharts representative of example machine readable instructions for implementing the version control system 107 of FIG. 1 is shown in FIGS. 7-9. In this example, the machine readable instructions comprise a program for execution by: (a) a processor such as the processor 1312 shown in the example computer 1300 discussed below in connection with FIG. 6, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 1312, but persons of ordinary skill in the art will readily appreciate that the entire program and/or parts thereof could alternatively be executed by a device other than the processor 1312 and/or embodied in firmware or dedicated hardware in a well known manner (e.g., it maybe implemented by an application specific integrated circuit (ASIC), a programmable logic device (PLD), a field programmable logic device (FPLD), discrete logic, etc.). For example, any or all of the version control system 107, version tracker 108, security monitor 109, and unique ID tracker 112 could be implemented by software, hardware, and/or firmware. Also, some or all of the machine readable instructions represented by the flowchart of FIGS. 7-9 may be implemented manually. Further, although the example program is described with reference to the flowchart illustrated in FIGS. 7-9, persons of ordinary skill in the art will readily appreciate that many other methods of implementing the example machine readable instructions may alternatively be used. For example, the order of execution of the blocks may be changed, and/or some of the blocks described may be changed, eliminated, or combined.

FIG. 7 is a flow diagram representative of machine readable instructions that may be executed in response to an INSERT operation performed on the database. The instructions shown in FIG. 7 may be initiated by a trigger on the INSERT command of the database. For example, a trigger may be inserted in the DBMS 104 of FIG. 1 to call the version tracker 108 and/or the security monitor 109 when the user input 102 submits a request to the DBMS 104 to perform an INSERT operation on the primary database 106. In other words, when an INSERT command is called, the instructions of FIG. 7 are performed. When the program of FIG. 7 is called, the unique ID tracker 112 provides a new unique ID from a unique ID sequence (block 702). The version tracker 108 then inserts the data for the inserted record into a history table associated with the primary table in which the data is to be inserted such as, for example, a table in the historical database 110 associated with a table in the primary database 106 (block 704). Then, the version tracker 108 inserts the unique ID and other information into the history table in association with the inserted record (block 706). The other information may include the name of the user that performed the INSERT, the date, and the time. The version tracker 108 then sets the version number for the row to 0 (block 708).

After the version tracker 108 updates the history table, the data associated with the INSERT command is inserted in the primary table by the DBMS 104 (block 710). Then, the version tracker 108 inserts the unique ID associated with the record into the primary table (block 712). The insertion of data in the primary table may be performed as part of the normal INSERT command or may be inserted by the same code that performs the insertion of data in the history table.

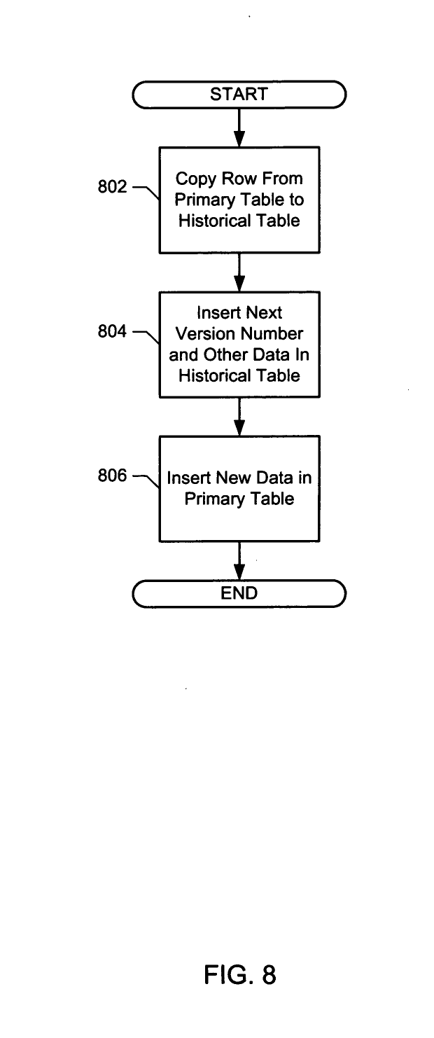

FIG. 8 is a flow diagram representative of machine readable instructions that may be executed in response to an UPDATE operation performed on a row in the database. The version tracker 108 copies the data stored in the primary table to a new record in the history table (block 802). For example, a trigger may be inserted in the DBMS 104 of FIG. 1 to call the version tracker 108 and/or the security monitor 109 when the user input 102 submits a request to the DBMS 104 to perform an UPDATE operation on the primary database 106. The version tracker 108 copies the data before the UPDATE operation has changed the data in the primary table. Then, the version tracker 108 updates the history table to include the next version number and other data associated with the UPDATE (block 804). The next version number may be obtained by the version tracker 108, which may maintain a stored sequence or may generate the version number by finding the largest version number in the history table associated with the record and adding 1. The other information may include the name of the user that performed the UPDATE, the date, and the time. After the record has been added to the history table, the DBMS 104 updates the record in the primary table with the data specified in the UPDATE command (block 806).

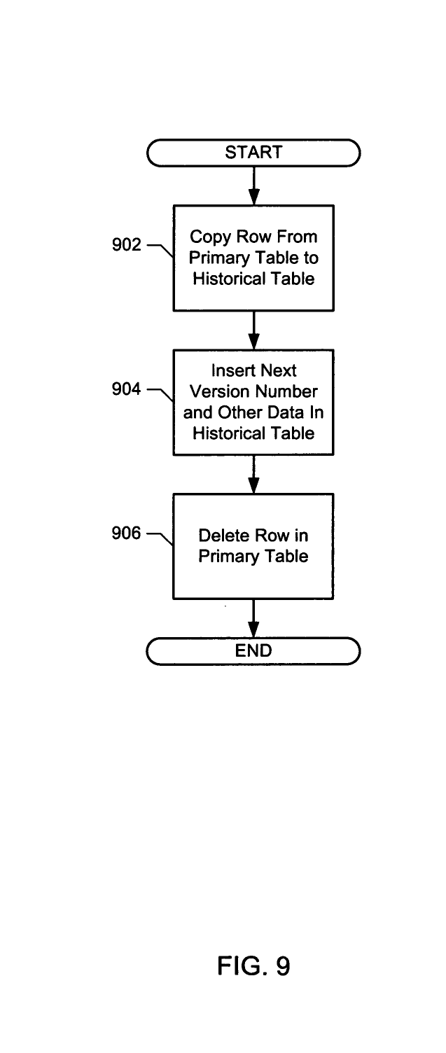

FIG. 9 is a flow diagram representative of machine readable instructions that may be executed in response to a DELETE operation performed on a row in the database. The version tracker 108 copies the data stored in the primary table to a new record in the history table (block 902). For example, a trigger may be inserted in the DBMS 104 of FIG. 1 to call the version tracker 108 and/or the security monitor 109 when the user input 102 submits a request to the DBMS 104 to perform a DELETE operation on the primary database 106. The version tracker 108 copies the data before the DELETE operation has been performed by the DBMS 104 on the primary table. Then, the version tracker 108 updates the new record in the history table with the next version number and other data associated with the DELETE (block 904). The version tracker 108 may obtain the next version number from a stored sequence or may generate the version number by finding the largest version number in the history table associated with the record and adding 1. The other information may include the name of the user that performed the DELETE, the date, and the time. After the version tracker 108 adds the record to the history table, the record in the primary table is deleted by the DBMS 104 (block 906).

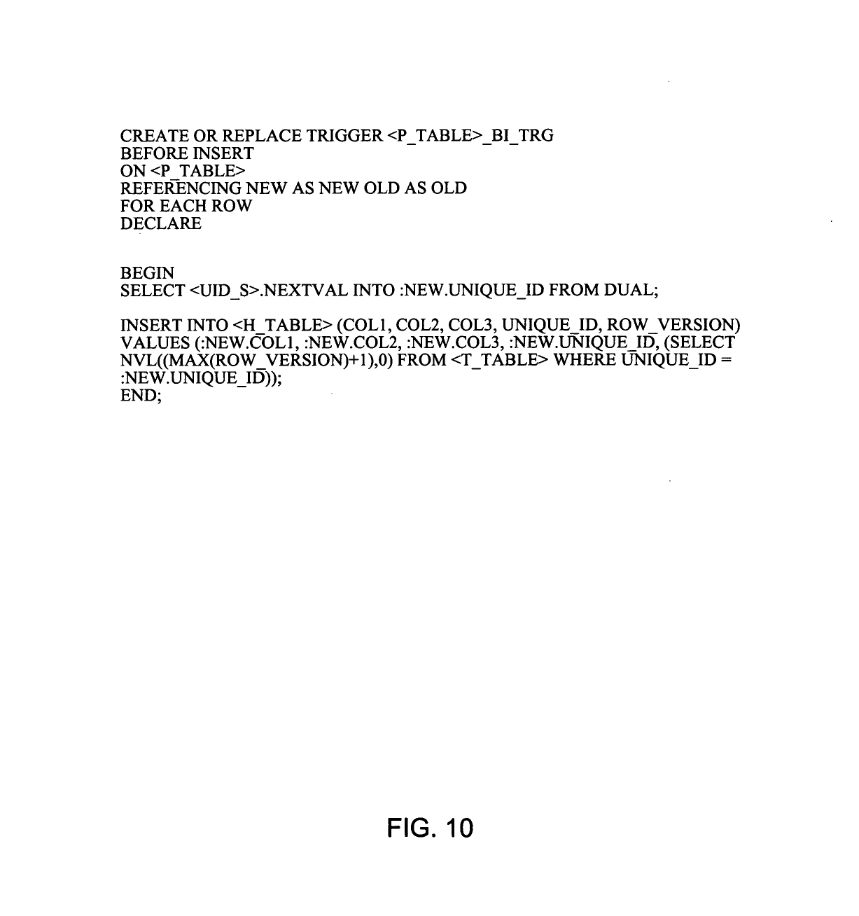

FIGS. 10-12 illustrate example pseudo code corresponding to the machine readable instructions illustrated in FIGS. 7-9, respectively and instructions for implementing the same as triggers in an Oracle database. However, persons of ordinary skill will recognize that similar code may be implemented for other types of databases. The example implementations abbreviate the primary table as P_TABLE, the historical table as H_TABLE, the unique ID tracker as UID_S, the unique ID column in the P_TABLE and H_TABLE as UNIQUE_ID, and the row version column in the H_TABLE as ROW_VERSION.

In the example of FIGS. 10-12, each of the sets of pseudo code for the triggers includes a preamble (the pseudo code prior to the ‘BEGIN’ command). The preamble creates/installs the corresponding trigger in the DBMS 104 or in any other portion of the database system capable of recognizing instructions to modify a primary database (e.g., primary database 106). A person of ordinary skill in the art will recognize that, while the preamble pseudo code is associated with syntax for an Oracle database, code of other syntax may be used to create/install the triggers in any other type of database.

FIG. 10 illustrates an example manner of inserting an INSERT trigger in an Oracle database. It also illustrates an example manner of implementing the machine readable instructions illustrated in FIG. 7. When executed, the INSERT trigger obtains the next unique ID value from the unique ID sequence. Then it inserts a copy of the data to be inserted in the primary table and the obtained unique ID into the history table. In addition, the INSERT trigger inserts the next consecutive row version in the history table. Then the INSERT trigger finishes and allows the INSERT operation to proceed in inserting data in the primary table.

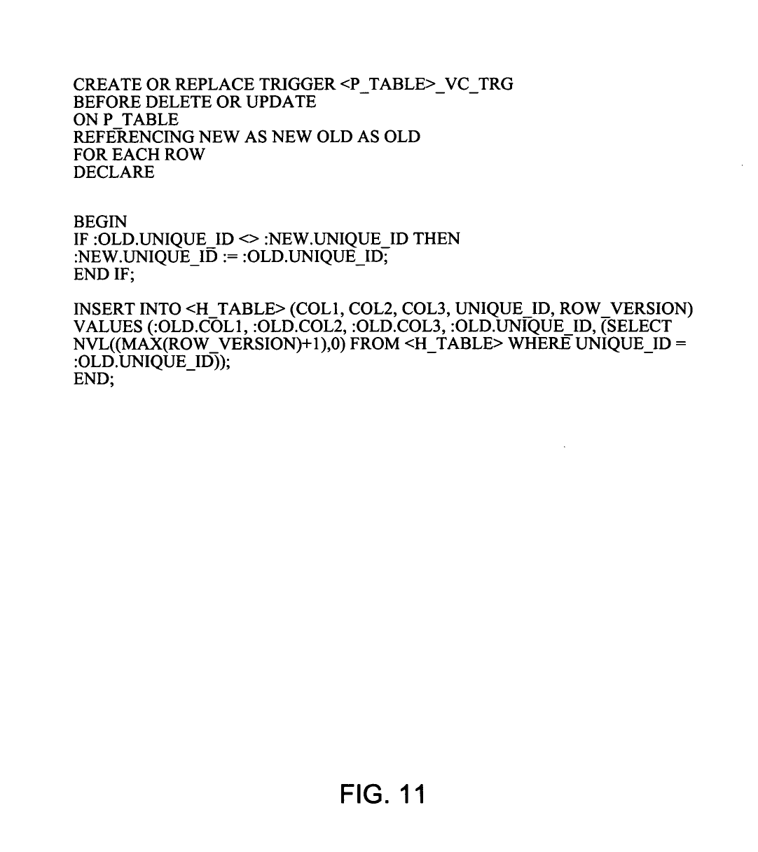

FIG. 11 illustrates an example manner of inserting an UPDATE/DELETE trigger in an Oracle database. It also illustrates an example manner of implementing the machine readable instructions illustrated in FIG. 8. When executed, the UPDATE/DELETE trigger initially checks to ensure that the DBMS is not attempting to change the unique ID field in the primary table. If the DBMS is attempting to change the unique ID, the UPDATE/DELETE trigger replaces the new unique ID with the original unique ID so that when the primary table is updated, the unique ID does not change. Then the UPDATE/DELETE trigger inserts a copy of the data from the primary table before the UPDATE/DELETE operation is performed in the history table. In addition, the UPDATE/DELETE trigger obtains the next consecutive row version and inserts the row version in the history table. Then the UPDATE/DELETE trigger finishes and allows the DBMS to update or delete the referenced row according to input instructions.

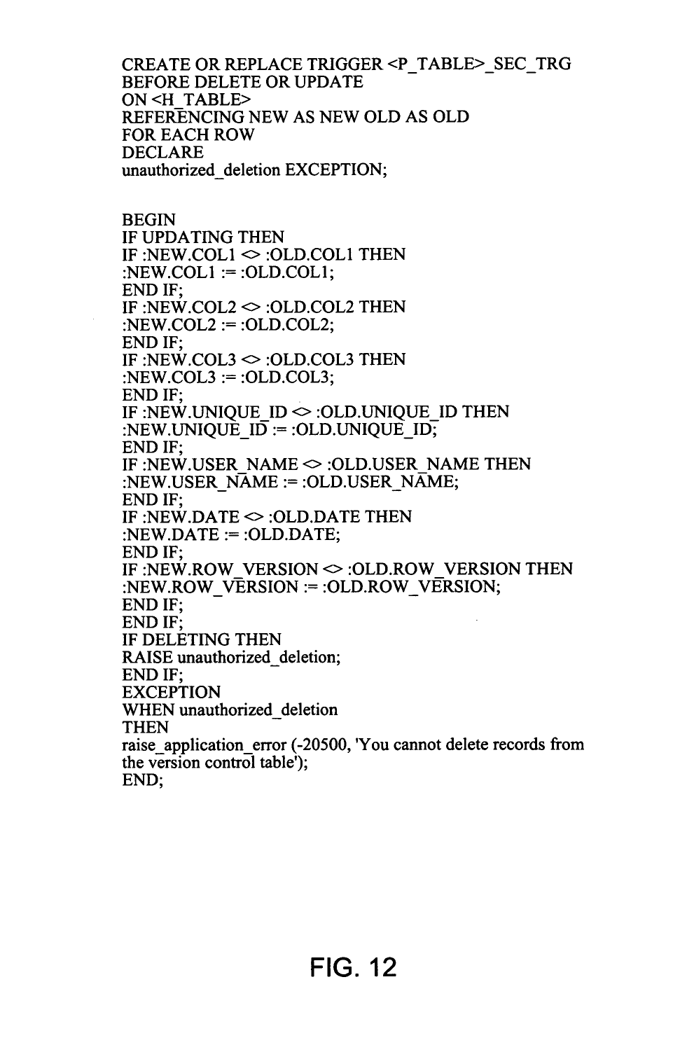

FIG. 12 illustrates an example manner of inserting a SECURITY trigger in an Oracle database. The SECURITY trigger is activated when an UPDATE or DELETE operation is performed on the history table by a user. When executed, the SECURITY trigger determines if the DBMS is attempting to change the values stored in any of the columns of the history table. If the DBMS is attempting to change the values, the SECURITY trigger replaces the updated data with the original data stored in the history table. In other words, the data in the history table will not be changed. If the SECURITY table determines that the DBMS is attempting to delete a record in the history table, the SECURITY trigger issues a software exception which stops the DELETE operation by the DBMS. If the DBMS was not attempting to the delete a record, the SECURITY trigger then allows the DBMS operation to continue.

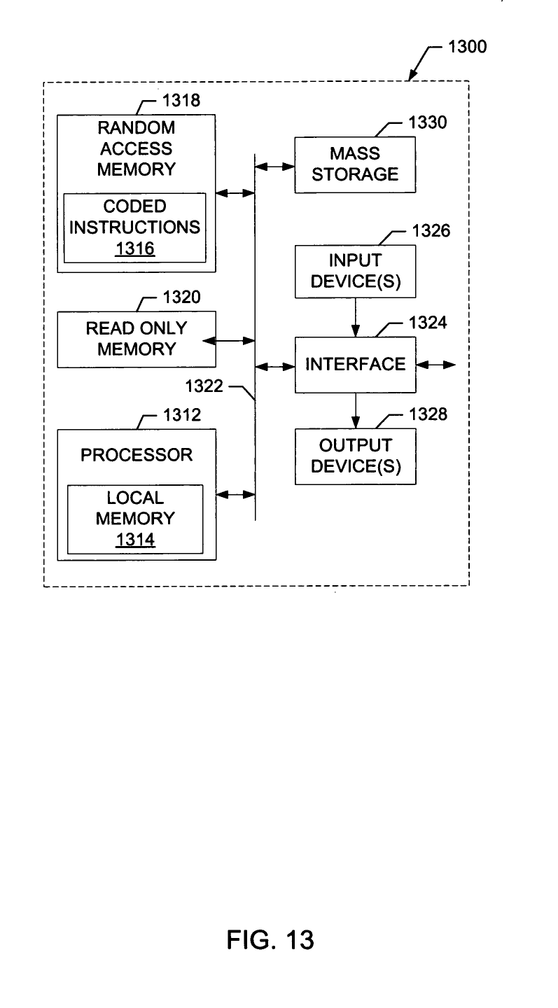

FIG. 13 is a block diagram of an example computer 1300 capable of executing the machine readable instructions represented by FIGS. 7-8 to implement the apparatus and/or methods disclosed herein. The computer 1300 can be, for example, a server, a personal computer, a personal digital assistant (PDA), an Internet appliance, a DVD player, a CD player, a digital video recorder, a personal video recorder, a set top box, or any other type of computing device.

The system 1300 of the instant example includes a processor 1312 such as a general purpose programmable processor. The processor 1312 includes a local memory 1314, and executes coded instructions 1316 present in the local memory 1314 and/or in another memory device. The processor 1312 may execute, among other things, the example machine readable instructions illustrated in FIGS. 7-9. The processor 1312 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1312 is in communication with a main memory including a volatile memory 1318 and a non-volatile memory 1320 via a bus 1322. The volatile memory 1318 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1320 may be implemented by flash memory and/or any other desired type of memory device. Access to the main memory 1318, 1320 is typically controlled by a memory controller (not shown) in a conventional manner.

The computer 1300 also includes a conventional interface circuit 1324. The interface circuit 1324 may be implemented by any type of well known interface standard, such as an Ethernet interface, a universal serial bus (USB), and/or a third generation input/output (3GIO) interface.

One or more input devices 1326 are connected to the interface circuit 1324. The input device(s) 1326 permit a user to enter data and commands into the processor 1312. The input device(s) can be implemented by, for example, a keyboard, a mouse, a touchscreen, a track-pad, a trackball, isopoint and/or a voice recognition system.

One or more output devices 1328 are also connected to the interface circuit 1324. The output devices 1328 can be implemented, for example, by display devices (e.g., a liquid crystal display, a cathode ray tube display (CRT), a printer and/or speakers). The interface circuit 1324, thus, typically includes a graphics driver card.

The interface circuit 1324 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1300 also includes one or more mass storage devices 1330 for storing software and data. Examples of such mass storage devices 1330 include floppy disk drives, hard drive disks, compact disk drives and digital versatile disk (DVD) drives.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

This patent contemplate examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method for database version control comprising:
receiving a request to modify a primary database;
in response to the request, inserting an entry in a historical table;
storing information reflecting the modification in the historical table;
modifying the primary database according to the request; and
storing a unique identifier associated with the record in the historical table.

2. A method as defined in claim 1 wherein the request to modify the primary database is a request to insert an entry in the primary database, a request to update an entry in the primary database, or a request to delete an entry from the primary database.

3. A method as defined in claim 1 wherein the record comprises data from the primary database that is to be modified by the request and/or data associated with the request.

4. A method as defined in claim 1 further comprising storing at least one of: a name of a user that made the request, a value indicating a version of the record, a value indicating the type of the request, a date that the request was processed, or a time that the request was processed.

5. A method as defined in claim 1 wherein a trigger is used to detect the request.

6. A method as defined in claim 1 wherein the unique identifier is obtained from a number stored in a sequence.

7. A method as defined in claim 1 wherein the unique identifier is inserted in the primary database.

8. A method as defined in claim 1 further comprising:
receiving a request to modify the historical table;
in response to the request to modify the historical table, at least one of modifying the request so that no modification occurs to the historical table, blocking the request, or implementing the request if predefined modification criteria are met.

9. A method as defined in claim 1 wherein the primary database is a primary table.

10. An article of manufacture storing machine readable instructions which, when executed, cause a machine to:
receive a request to modify a first table of a database;
in response to the request, insert an entry in a second table;
store information reflecting the modification in the second table;
modify the first table according to the request; and
store a unique identifier associated with the record in the second table.

11. An article of manufacture as defined in claim 10 wherein the request to modify the first table is a request to insert an entry in the first table, a request to update an entry in the first table, or a request to delete an entry from the first table.

12. An article of manufacture as defined in claim 10 wherein the record comprises data from the first table that is to be modified by the request and/or data associated with the request.

13. An article of manufacture as defined in claim 10 wherein the machine readable instructions, when executed, further cause the machine to:
receive a request to modify the second table;
in response to the request to modify the second table, at least one of modify the request so that no modification occurs to the second table, block the request from proceeding, or implement the request if a predetermined modification criteria is met.

14. A version control system for a database having a first table comprising:
a second table to store historical data associated with the first table;
a version tracker to insert a record in the second table in response to a request to modify the first table; and
a unique identifier tracker to assign identification numbers to entries in the second table.

15. A version control system as defined in claim 14 wherein the version tracker monitors user input to detect the request.

16. A version control system as defined in claim 14 wherein the request is a request to insert an entry in the first table, a request to update an entry in the first table, a request to delete an entry from the first table, or a request to modify an entry in the second table.

17. A version control system as defined in claim 16 further comprising a security monitor to prevent modification if the request is an unauthorized request to modify an entry in the second table.

18. A version control system as defined in claim 14 wherein the version tracker is to insert a unique identifier obtained from the unique identifier tracker in an entry of at least one of the first table or the second table.

19. A version control system as defined in claim 14 wherein the first table and the second table are in the same database.

20. A method of implementing a version control system in a database comprising:
inserting a unique identifier into each entry stored in the database;
creating a dataset for storing historical data; and
modifying a database management system to recognize a request from a user input to modify a first table in the database and, in response to the request, store data associated with the modification in the historical data dataset.

21. A method as defined in claim 20 wherein the historical dataset is a table in the database.

22. A method as defined in claim 20 further comprising creating a sequence in the database capable of storing the next available unique identifier.

23. A method as defined in claim 20 further comprising modifying the database management system to recognize a second request from the user input to modify the historical data dataset and, in response to the second request, stop the request from modifying the historical data dataset.

24. A method as defined in claim 20 wherein modifying the database management system includes inserting at least one trigger in the database management system.
